(19) United States
(12) Patent Application Publication
(10) Pub. No.: US 2011/0064299 A1
(43) Pub. Date: Mar. 17, 2011

(54) IMAGE PROCESSING APPARATUS AND IMAGE PROCESSING METHOD

(75) Inventors: Yitong ZHANG, Saitama-shi (JP); Koichi Yahagi, Saitama-shi (JP)

(73) Assignee: FUJIFILM Corporation, Tokyo (JP)

(21) Appl. No.: 12/880,654

(22) Filed: Sep. 13, 2010

(30) Foreign Application Priority Data
Sep. 14, 2009 (JP) 2009-212163

(51) Int. Cl. G06K 9/00

(52) U.S. Cl. 382/154

(57) ABSTRACT

An image processing method, includes: detecting a correspondence of each pixel between images acquired by imaging a subject from a plurality of viewpoints; calculating depth information of a non-occlusion pixel and creating a depth map including the depth information; regarding a region consisting of occlusion pixels as an occlusion region and determining an image reference region including the occlusion region and a peripheral region; dividing the image reference region into clusters on the basis of an amount of feature in the image reference region; calculating the depth information of the occlusion pixel in each cluster on the basis of the depth information in at least one cluster from the focused cluster, and clusters selected on the basis of the amount of feature of the focused cluster in the depth map; and adding the depth information of the occlusion pixel to the depth map.

### BACKGROUND OF THE INVENTION

### 1. Field of the Invention

The presently disclosed subject matter relates to an image processing apparatus and an image processing method capable of accurately acquiring depth information of an occlusion region when creating a depth information map of a 3D image acquired by imaging from a plurality of viewpoints.

2. Description of the Related Art

3D (three-dimensional) digital cameras including a plurality of imaging systems have been provided for users. A 3D image acquired by imaging using a 3D digital camera can be displayed in a stereoscopically viewable manner by means of a 3D monitor implemented in the 3D digital camera or a widescreen 3D monitor device, which is referred to as a 3D viewer. The 3D image can also be printed in a stereoscopically viewable manner on a print medium by means of a 3D print system. An image processing of taking images from a plurality of viewpoints and creating a 3D image from an arbitrary virtual viewpoint to present a user with a 3D image with higher image quality, has been known.

Japanese Patent No. 3593466 discloses a configuration that generates two or more depth maps from images from different viewpoints and generates a virtual viewpoint depth map viewed from a virtual viewpoint on the basis of these depth maps. Depth information of a region (occlusion region) invisible from a certain viewpoint is interpolated by information from another viewpoint. Pixels whose depth information cannot be determined are linearly interpolated by depth information of pixels therearound and further subjected to a smoothing process. A virtual viewpoint image is created by rearranging and reconstructing pixels of a multi-viewpoint image (actual viewpoint image) on the basis of the virtual depth map.

Japanese Patent Application Laid-Open No. 2004-246667 discloses a configuration that acquires location information of a subject with reference to image data taken from a viewpoint where an occlusion does not occur when an occlusion occurs.

Japanese Patent Application Laid-Open No. 09-27969 discloses a configuration that detects an outline of an object and makes portions at the outline discontinuous when estimating a parallax at an occlusion region.

### SUMMARY OF THE INVENTION

In a 3D image, there is a region (so-called an “occlusion region”) that has been imaged from one viewpoint but has not been imaged from the other viewpoint. In order to accurately create a 3D image from an arbitrary intermediate virtual viewpoint on the basis of a 3D image, it is required to accurately acquire depth information of the occlusion region.

The configuration described in Japanese Patent No. 3593466 linearly interpolates depth information of the occlusion region only using depth information of pixels therearound. This configuration thereby offers a problem that an interpolation using depth information corresponding to a subject different from that in an occlusion region increases an error in the depth information. Japanese Patent Application Laid-Open No. 2004-246667 also offers a similar problem.

Further, an example described in Japanese Patent Application Laid-Open No. 2004-246667 requires at least three cameras for an occlusion processing, and is unsuitable for a binocular camera.

The configuration described in Japanese Patent Application Laid-Open No. 09-27969 acquires an outline from the entire image. This configuration thereby increases the amount of calculation and is not accurate in region division.

The presently disclosed subject matter is made in view of these situations. It is an object of the presently disclosed subject matter to provide an image processing apparatus and an image processing method capable of accurately acquiring depth information of an occlusion region when creating a depth information map of images taken by imaging a subject from respective viewpoints.

In order to achieve the object, a first aspect of the presently disclosed subject matter provides an image processing apparatus including: an image input device configured to input a plurality of images acquired by imaging a subject from a plurality of viewpoints; a correspondence detection device configured to detect a correspondence of each pixel between the images; a depth map creation device configured to calculate depth information of the pixel whose correspondence has been detected and creates a depth map including the depth information; an image reference region determination device configured to regard a region consisting of occlusion pixels, whose correspondences have not been detected, as an occlusion region and determine an image reference region including the occlusion region and a peripheral region surrounding the occlusion region; a region dividing device configured to divide the image reference region into a plurality of clusters on the basis of an amount of feature of a partial image in the image reference region; an occlusion depth information calculation device configured to focus on each cluster and calculate the depth information of the occlusion pixel in the focused cluster on the basis of the depth information in at least one cluster from the focused cluster, and clusters selected on the basis of the amount of feature of the focused cluster in the depth map; and a depth map update device configured to add the depth information of the occlusion pixel to the depth map.

That is, the image reference region including the occlusion region and the peripheral region surrounding the occlusion region are divided into the plurality of clusters on the basis of the amount of feature of the partial image in the image reference region, and, with the focus on each cluster, the depth information in the occlusion region in each focused cluster is calculated on the basis of the depth information in at least one cluster from the focused cluster, and clusters selected on the basis of the amount of feature of the partial image. Accordingly, information irrelevant to the occlusion region is eliminated from the peripheral information of the occlusion region while effective information related to the occlusion region is reflected, in comparison with image processing apparatuses that simply interpolate the depth information in the occlusion region by means of a linear interpolation. Therefore, accuracy of the depth information in the occlusion region is improved. Further, it is only required to refer to the amount of feature and the depth map for each cluster, thereby decreasing the amount of calculation and enabling the processing speed to be enhanced.

Note that it is not necessary that the depth information be an actual depth value from a viewpoint (an actual viewpoint or a virtual viewpoint). The information may be information corresponding to the depth. For example, a signed amount of parallax may be used as the depth information. If there is a variable parameter other than the amount of parallax, the depth information may be represented by a combination of the signed amount of parallax and the variable parameter thereof. That is, after the depth map is updated, the information may be represented in a format that can easily be dealt with for stereoscopic display, creation of a stereoscopic print or another image processing.

It is not necessary to calculate the depth information in a pixel-by-pixel manner. Instead, the information may be calculated for each pixel group including a certain number of pixels.

A second aspect of the presently disclosed subject matter provides an image processing apparatus according to the first aspect, wherein the region dividing device divides the image reference region on the basis of, at least one of color, luminance, spatial frequency and texture of the partial image which are used as the amount of feature.

Note that various pieces of color information, such as hue and chroma, can be used as the color. For example, a spatial frequency of luminance or a spatial frequency of a specific color (e.g., green) component may be used for the spatial frequency.

A third aspect of the presently disclosed subject matter provides an image processing apparatus according to the first or second aspect, wherein the occlusion depth information calculation device calculates an average value of the depth information of pixels whose correspondences have been detected for each cluster, and regards the average value as the depth information of the occlusion pixels.

That is, calculation of the average value for each cluster allows the depth information in the occlusion region to be calculated fast and appropriately.

A fourth aspect of the presently disclosed subject matter provides an image processing apparatus according to the first or second aspect, wherein the occlusion depth information calculation device regards an average value of the depth information in the focused cluster as the depth information of the occlusion pixels in the focused cluster when a pixel whose correspondence has been detected resides in the focused cluster, and selects a cluster whose amount of feature is the closest to the amount of the feature of the focused cluster from among the plurality of clusters in the image reference region and regards an average value of the depth information in the selected cluster as the depth information of the occlusion pixels in the focused cluster when the pixel whose correspondence has been detected does not reside in the focused cluster.

That is, even if the non-occlusion pixel does not reside in the cluster, the depth information in the cluster whose feature is similar is used, thereby allowing the depth information in the occlusion region to be accurately acquired.

A fifth aspect of the presently disclosed subject matter provides an image processing apparatus according to the first or second aspect, wherein the occlusion depth information calculation device calculates distribution information representing a distribution of the depth information for each cluster, and calculates the depth information of the occlusion pixel on the basis of the distribution information.

That is, even if the depth information is not flat (constant) but inclined in each cluster, the depth information in the occlusion region can accurately be acquired.

A sixth aspect of the presently disclosed subject matter provides an image processing apparatus according to the first to fifth aspect, wherein the image reference region determination device sets a nearly band-shaped peripheral region having a certain width on the periphery of the occlusion region.

That is, the image reference region can be determined easily and appropriately.

A seventh aspect of the presently disclosed subject matter provides an image processing apparatus according to the first to fifth aspect, wherein the image reference region determination device sets the peripheral region having a width with a certain ratio relative to a width of the occlusion region on the periphery of the occlusion region.

That is, the depth information in the occlusion region can accurately be acquired according to the width of the occlusion region.

Further, an eighth aspect of the presently disclosed subject matter provides an image processing method, including: a correspondence detection step that detects a correspondence of each pixel between images acquired by imaging a subject from a plurality of viewpoints; a depth map creation step that calculates depth information of the pixel whose correspondence has been detected and creates a depth map including the depth information; an image reference region determination step that regards a region consisting of occlusion pixels, whose correspondences have not been detected, as an occlusion region and determines an image reference region including the occlusion region and a peripheral region surrounding the occlusion region; a region dividing step that divides the image reference region into a plurality of clusters on the basis of an amount of feature of a partial image in the image reference region; an occlusion depth information calculation step that focuses on each cluster and calculates the depth information of the occlusion pixel in the focused cluster on the basis of the depth information in at least one cluster from the focused cluster, and clusters selected on the basis of the amount of feature of the focused cluster in the depth map; and a depth map update step that adds the depth information of the occlusion pixel to the depth map.

A ninth aspect of the presently disclosed subject matter provides an image processing method according to the eighth aspect, wherein the method divides the image reference region on the basis of, at least one of color, luminance, spatial frequency and texture of the partial image which are used as the amount of feature.

A tenth aspect of the presently disclosed subject matter provides an image processing method according to the eighth or ninth aspect, wherein the occlusion depth information calculation step calculates an average value of the depth information of pixels whose correspondences have been detected for each cluster, and regards the average value as the depth information of the occlusion pixels.

An eleventh aspect of the presently disclosed subject matter provides an image processing method according to the eighth or ninth aspect, wherein the occlusion depth information calculation step regards an average value of the depth information in the focused cluster as the depth information of the occlusion pixels in the focused cluster when a pixel whose correspondence has been detected resides in the focused cluster, and selects a cluster whose amount of feature is the closest to the amount of the feature of the focused cluster from among the plurality of clusters in the image reference region and regards an average value of the depth information in the selected cluster as the depth information of the occlusion pixels in the focused cluster when the pixel whose correspondence has been detected does not reside in the focused cluster.

A twelfth aspect of the presently disclosed subject matter provides an image processing method according to the eighth or ninth aspect, wherein the occlusion depth information calculation step calculates distribution information representing a distribution of the depth information for each cluster, and calculates the depth information of the occlusion pixel on the basis of the distribution information.

A thirteenth aspect of the presently disclosed subject matter provides an image processing method according to the eighth to twelfth aspect, wherein the image reference region determination step sets a band-shaped peripheral region having a certain width on the periphery of the occlusion region.

A fourteenth aspect of the presently disclosed subject matter provides an image processing method according to the eighth to twelfth aspect, wherein the image reference region determination step sets the peripheral region having a width with a certain ratio relative to a width of the occlusion region on the periphery of the occlusion region.

The presently disclosed subject matter is capable of accurately acquiring the depth information in the occlusion region when creating the depth information map of the images acquired by imaging from the plurality of viewpoints.

### BRIEF DESCRIPTION OF THE DRAWINGS

FIG. 1 is a block diagram illustrating a configuration of an example of an image processing apparatus according to the presently disclosed subject matter;

FIGS. 2A and 2B are illustration diagrams schematically illustrating an amount of parallax and depth information;

FIG. 3 is a flowchart illustrating a flow of an example of an image processing according to the presently disclosed subject matter;

FIGS. 4A and 4B are illustration diagrams schematically illustrating an example of an inputted left and right images;

FIG. 5 is an illustration diagram illustrating detection of a correspondence between images;

FIGS. 6A and 6B are illustration diagrams illustrating creation of a depth map;

FIGS. 7A and 7B are illustration diagrams illustrating detection of an occlusion region;

FIG. 8 is an illustration diagram illustrating determination of an image reference region;

FIG. 9 is an illustration diagram illustrating division of a region;

FIG. 10 is an illustration diagram illustrating calculation of depth information in the occlusion region;

FIG. 11 is an illustration diagram illustrating updating of the depth map;

FIGS. 12A and 12B are illustration diagrams illustrating a first example of calculating occlusion depth information;

FIGS. 13A and 13B are illustration diagrams illustrating a second example of calculating the occlusion depth information;

FIGS. 14A and 14B are illustration diagrams illustrating a third example of calculating the occlusion depth information; and

FIG. 15 is an illustration diagram illustrating an example of determining the image reference region.

### DETAILED DESCRIPTION OF THE PREFERRED EMBODIMENTS

An embodiment of the presently disclosed subject matter will hereinafter be described in detail according to the accompanying drawings.

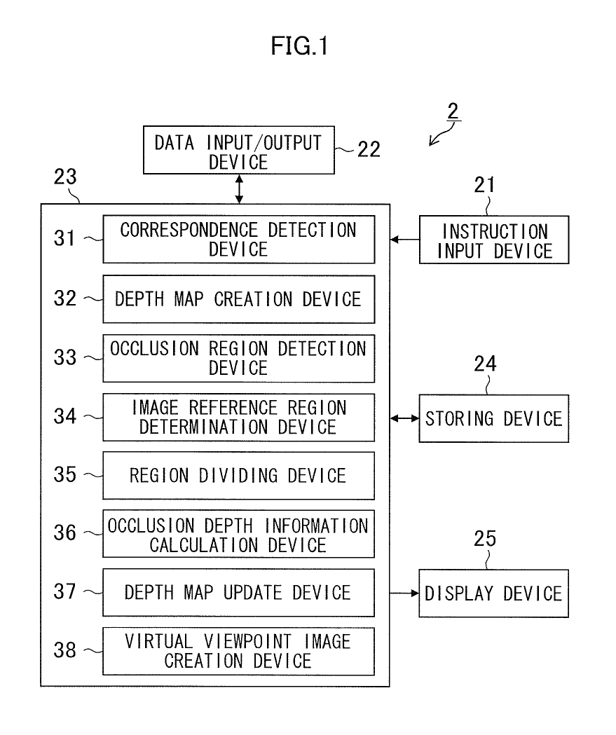

FIG. 1 is a block diagram illustrating an example of the overall configuration of an image processing apparatus according to the presently disclosed subject matter.

Referring to FIG. 1, the image processing apparatus 2 includes an instruction input device 21, a data input/output device 22, a CPU (central processing unit) 23, a storing device 24 and a display device 25. The CPU 23 includes a correspondence detection device 31, a depth map creation device 32, an occlusion region detection device 33, an image reference region determination device 34, a region dividing device 35, an occlusion depth information calculation device 36, a depth map update device 37 and a virtual viewpoint image creation device 38.

The instruction input device 21 is an input device for inputting an instruction of an operator (user). For example, this device includes a keyboard and a pointing device.

The data input/output device 22 is an input and output device for inputting and outputting various pieces of data. In this example, this device is particularly used for inputting an image data (hereinafter, simply referred to as an “image”) and outputting a virtual viewpoint image and a depth map. The data input/output device 22 includes, for example, a recording media interface for inputting (reading out) data from a removable recording media such as a memory card and outputting data to (writing data onto) the recording media, and/or a network interface for inputting data from a network and outputting data to the network.

In this example, the data input/output device 22 inputs a 3D image (also referred to as a “plural viewpoint image”) configured by a plurality of 2D (two-dimensional) images (also referred to as “single viewpoint images”) acquired by imaging a subject from a plurality of viewpoints.

The depth map is data representing depth information of pixels, which belong to at least one of the plurality of 2D images configuring the 3D image, in association with the positions of the pixels. The depth information of each pixel corresponds to the amount of parallax of each pixel. The amount of parallax (parallax amount) will be described later.

The CPU (central processing unit) 23 controls the elements of the image processing apparatus 2 and performs an image processing.

The correspondence detection device 31 detects a correspondence of the pixels between the 2D images configuring the 3D image. That is, a pixel is associated with a pixel between the 2D images from different viewpoints.

The depth map creation device 32 calculates the depth information of the pixels (hereinafter, referred to as “non-occlusion pixels”) whose correspondences have been detected, and creates the depth map including the depth information.

The occlusion region detection device 33 detects a region of pixels (hereinafter, referred to as “occlusion pixels”) whose correspondences have not been detected as an occlusion region. A region of non-occlusion pixels whose correspondences have been detected is a non-occlusion region.

The image reference region determination device 34 determines an image reference region, which is for reference of a partial image in order to calculate the depth information of the occlusion pixel and includes an occlusion region and a peripheral region surrounding the occlusion region. A specific example thereof will be described later in detail.

The region dividing device 35 divides the image reference region into a plurality of clusters on the basis of an amount of feature of a partial image in the image reference region. A specific example thereof will be described later in detail.

The occlusion depth information calculation device 36 calculates the depth information of a pixel (occlusion pixel) in the occlusion region. More specifically, calculation is performed, according to each cluster, on the basis of the depth information in at least one cluster from the focused cluster, and clusters selected on the basis of the amount of feature of the focused cluster in the depth map. A specific example thereof will be described later in detail.

The depth map update device 37 updates the depth map by adding the depth information of the occlusion pixel to the depth map.

The virtual viewpoint image creation device 38 creates a 3D image (virtual viewpoint image) viewed from an arbitrary virtual viewpoint, on the basis of an actual viewpoint image (i.e., a 3D image input by the data input/output device 22) and the updated depth map.

The storing device 24 is a storing device that is for storing various pieces of data and includes at least one of a nonvolatile memory and a disk.

The display device 25 is a display device such as a liquid crystal display device. The display device 25 of this example is used for a user interface with an operator of the image processing apparatus 2, and is not necessarily capable of stereoscopic display.

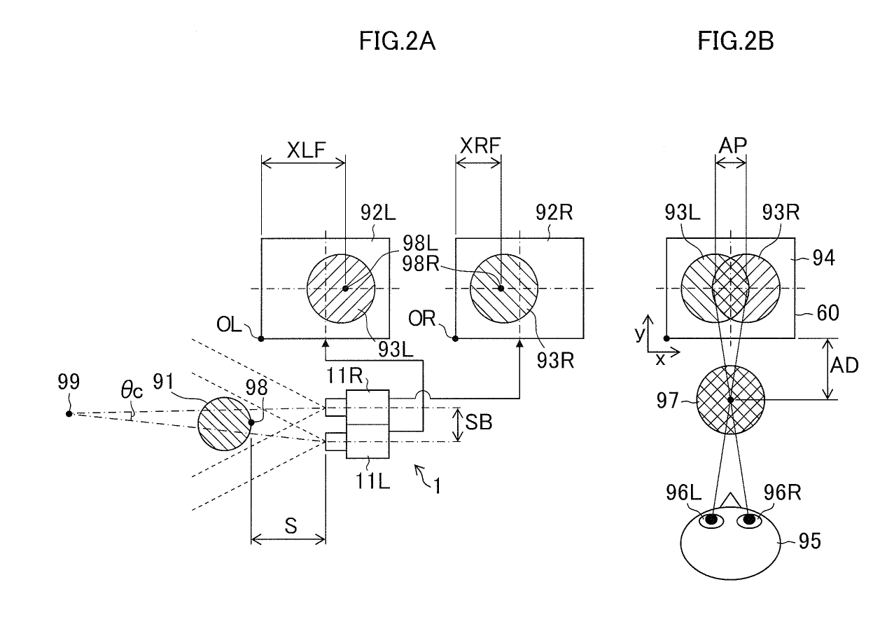

Next, the amount of parallax and the depth information will be described using FIGS. 2A and 2B.

As illustrated in FIG. 2A, a 3D digital camera 1 includes a plurality of imaging systems 11L and 11R. Each of the imaging systems 11L and 11R includes an imaging optical system having a zoom lens, a focusing lens and a diaphragm, and an imaging element such as a CCD (charge-coupled device) sensor. In order to facilitate understanding of the presently disclosed subject matter, it will be described such that the baseline length SB (the separation between the optical axes of the imaging systems 11L and 11R) and the angle of convergence θc (the angle between the optical axes of the imaging systems 11L and 11R) in the 3D digital camera 1 are fixed.

The plurality of imaging systems 11L and 11R image a subject 91 (a sphere in this example) from a plurality of viewpoints, thereby generating a plurality of 2D images (a left image 92L and a right image 92R). The generated 2D images 92L and 92R include subject images 93L and 93R, respectively, where the same subject 91 is projected. A 3D image 94 is reproduced by displaying these 2D images 92L and 92R so as to be superimposed on each other on a monitor 60 capable of stereoscopic display, or by 3D display. As illustrated in FIG. 2b, a viewer 95 views the 3D image 94 on a monitor 60 with both eyes 96L and 96R. This viewing allows the viewer 95 to view a virtual image 97 of the subject 91 in a pop-up manner. In FIG. 2A, since the subject 91 resides at a position nearer than a cross point 99 between the optical axes, the virtual image 97 is viewed in the pop-up manner. On the other hand, when the subject resides at a position farther than the cross point 99, the virtual image is viewed in a recessed manner.

As illustrated in FIG. 2A, within an extent where the subject distance S is smaller than a distance to the cross point 99, the smaller the subject distance S is, the greater the difference |XLF-XRF| between the center coordinates XLF and XRF of the subject images 93L and 93R on the 3D image 94 becomes. That is, the smaller the subject distance S is, the farther corresponding pixels in the 2D images 92L and 92R are separated. Here, the difference |XLF-XRF| only has an x coordinate, which is represented as an amount of parallax AP. That is, provided that the baseline length SB and the angle of convergence θc are determined; before the cross point 99, the smaller the subject length S is, the greater the AP becomes and the greater the pop-up amount of a virtual image 97 that the viewer 95 senses becomes accordingly.

Provided that the baseline length SB, the angle of convergence θc and the focal length are determined, the depth information of pixels of each 2D image can be represented using the amount of parallax AP. For example, if the subject 91 resides before the cross point 99, a value which is the amount of parallax AP with a positive sign is the depth information. If the subject 91 resides after the cross point 99, a value which is the amount of parallax AP with a negative sign is the depth information. The depth information corresponding to the cross point 99 is 0 (zero). In these cases, if the depth information is positive, the larger the value of the depth information is, the larger the pop-up amount AD of the virtual image 97 of the subject 91 becomes; if the depth information is negative, the larger the absolute value of the depth information is, the larger the recessed amount of the virtual image 97 of the subject 91 becomes.

Note that, since the depth information also corresponds to the subject distance S, the depth information can also be represented using the subject distance S.

The description has exemplarily been made on a case where the baseline length SB and the angle of convergence θc are constant. Instead, in a case of a configuration whose angle of convergence θc is variable, the pop-up amount AD varies according to the angle of convergence θc and the subject distance S. In a case of a configuration whose baseline length SB is also variable in addition to the angle of convergence θc, the pop-up amount AD varies according to the baseline length SB, the angle of convergence θc and the subject distance S. Even in a case where the baseline length SB and the angle of convergence θc are constant, when the amount of parallax AP is changed by shifting pixels between the 2D images 92L and 92R, the pop-up amount AD is also changed.

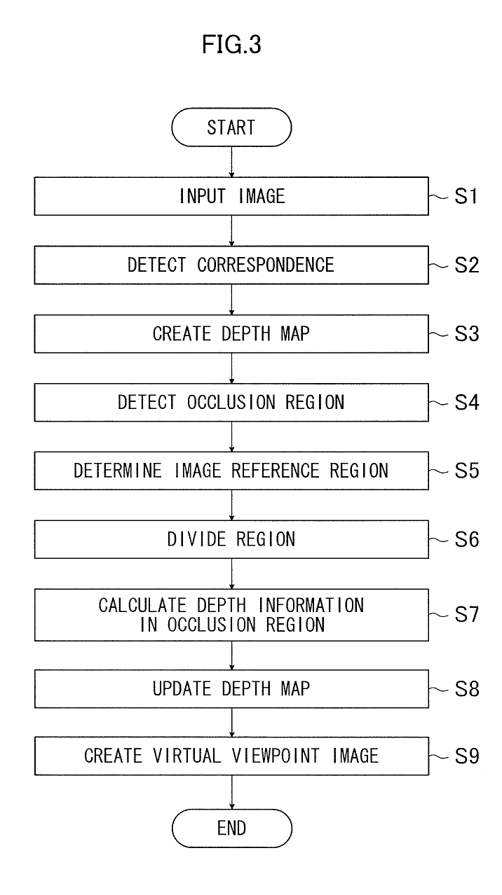

FIG. 3 is a flowchart illustrating a flow of an example of an image processing in the image processing apparatus 2.

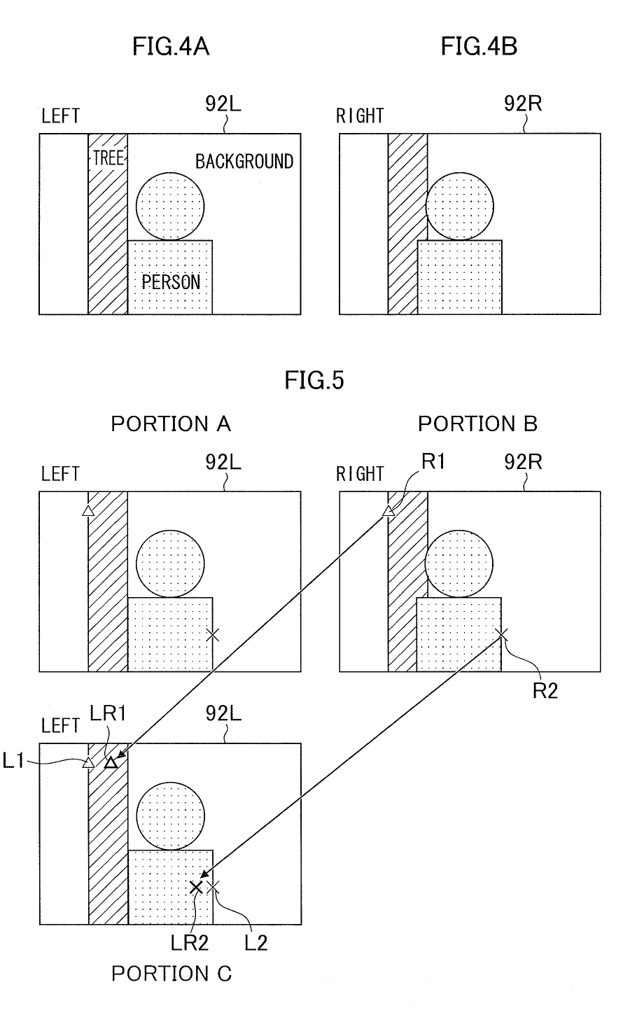

In step S1, the data input/output device 22 inputs a 3D image. The 3D image includes a plurality of 2D images 92L and 92R acquired by imaging the subject from a plurality of viewpoints using the 3D digital camera 1 (See FIG. 2A). The description will hereinafter be made, provided that the left image 92L and the right image 92R illustrated in FIGS. 4A and 4B, respectively, have been input.

In step S2, the correspondence detection device 31 detects the correspondence of pixels between the 2D images 92L and 92R. For example, as illustrated in FIG. 5, for all the pixels of the right image 92R, the correspondence detection device 31 detects the corresponding pixels L1 and L2 of the left image 92L corresponding to the respective focused pixels R1 and R2 of the right image 92R. Note that the pixels LR1 and LR2 of the left image 92L are pixels at positions onto which the focused pixels R1 and R2 of the right image 92R are simply projected.

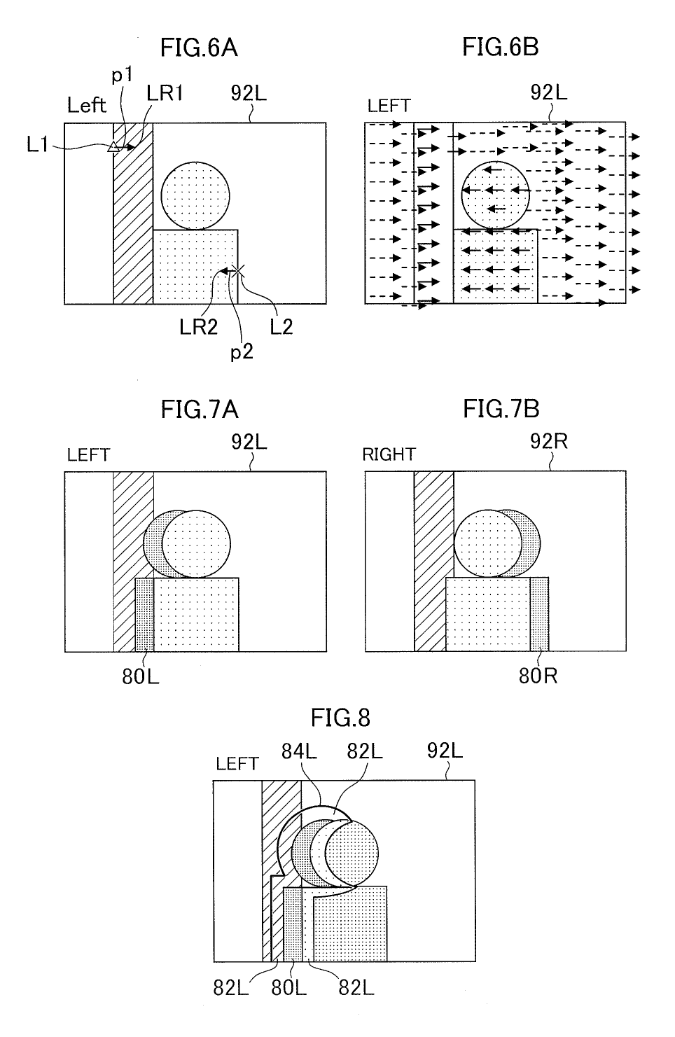

In step S3, depth map creation device 32 calculates the depth information of pixels (non-occlusion pixels) whose correspondence has been detected (i.e. a non-occlusion pixel of the right image 92R is a pixel to which the corresponding pixel exists in the left image 92L). And, the depth map creation device 32 creates the depth map including the depth information. In FIG. 6A, the depth information of the pixel L1 is represented by the arrow p1; the depth information of the pixel L2 is represented by arrow p2. Here, p1 corresponds to a vector between L1-LR1, and p2 corresponds to a vector between L2-LR2. In actuality, the depth information in this embodiment is represented as a signed amount of parallax, using a sign and an absolute value. FIG. 6B schematically illustrates a map projecting the left image 92L to the right image 92R by means of an arrangement of arrows, and is referred to as a depth map of the left image 92L. As illustrated in FIG. 6B, the depth map may be information associating the depth information of each pixel to the position of each pixel. In actuality, the depth map in this example may be represented with an arrangement of the signed amounts of parallax. Note that, although the description has been made using the example of creating the depth map of the left image 92L, the depth map of the right image 92R is likewise made.

In step S4, as illustrated in FIGS. 7A and 7B, the occlusion region detection device 33 detects occlusion regions 80L and 80R. That is, the regions 80L and 80R of occlusion pixels, on which correspondences cannot be detected between the 2D images 92L and 92R, are regarded as occlusion regions. The occlusion region 80L of the left image 92L is a region invisible from the right imaging system 11R in FIG. 2A. The occlusion region 80R of the right image 92R is a region invisible from the left imaging system 11L in FIG. 2A.

In step S5, as illustrated in FIG. 8, the image reference region determination device 34 determines an image reference region 84L including the occlusion region 80L and a nearly band-shaped peripheral region 82L surrounding the occlusion region 80L. Note that, although the description has been made using the example of image reference region 84L of the left image 92L, the image reference region of the right image 92R is likewise determined.

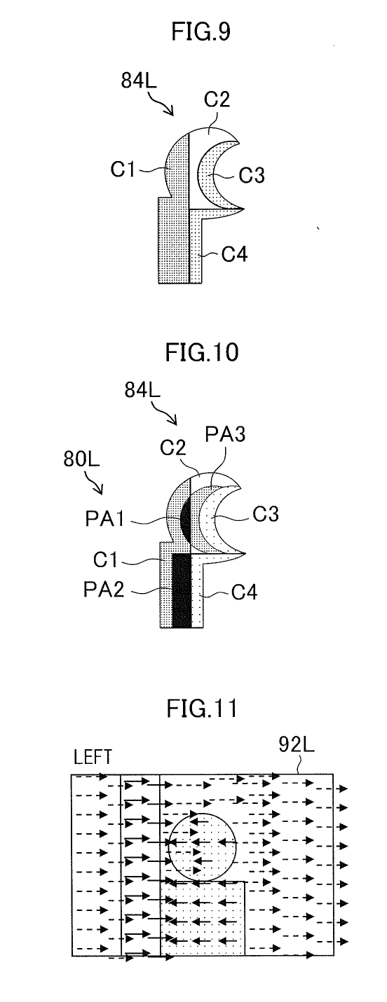

In step S6, as illustrated in FIG. 9, the region dividing device 35 divides the image reference region 84L into a plurality of clusters C1 to C4 (divided regions) on the basis of amounts of feature of the partial images in the image reference region 84L. For example, the region dividing device 35 divides the image reference region 84L into the plurality of clusters C1 to C4 on the basis of at least one of color, luminance, spatial frequency and texture. Various pieces of color information such as hue and chroma can be used as the color. For example, the spatial frequency of the luminance may be used as the spatial frequency. The spatial frequency of a specific color (e.g., green) component may be used.

In step S7, the occlusion depth information calculation device 36 calculates the depth information in the occlusion region 80L (PA1, PA2 and PA3). In FIG. 10, among the occlusion regions PA1, PA2 and PA3, the regions PA1 and PA2 designate pixels configuring a partial image of a tree in the left image 92L and depth information; the region PA3 designates pixels configuring a partial image of a person in the left image 92L.

More specifically, the occlusion depth information calculation device 36 sequentially focuses on clusters C1, C2, C3 and C4 in the image reference region 84L, and calculates the depth information as follows. First, calculation on the cluster C1 is performed. The pixels (i.e., non-occlusion pixels whose correspondences with the pixels of the right image 92R have been detected) where the depth information has already been detected exist in the cluster C1. Accordingly, on the basis of the depth information, the depth information of the occlusion partial regions PA1 and PA2 in the cluster C1 illustrated in FIG. 10 is calculated. Note that a specific example of calculation will be described later. Next, calculation on the cluster C2 in FIG. 9 is performed. The pixels whose depth information has already been detected exist in the cluster C2. Accordingly, on the basis of the depth information, the depth information of the occlusion partial region PA3 in the cluster C2 illustrated in FIG. 10 is calculated. Note that, since the any occlusion region does not exist in the clusters C3 and C4, it is not required to calculate the depth information here.

If only the occlusion pixels reside in the focused cluster, the depth information of the occlusion region in the focused cluster may be calculated on the basis of the depth information of another cluster selected on the basis of the amount of feature of the partial image in the focused cluster. An example in such a case will be described later.

In step S8, depth map update device 37 updates the depth map. FIG. 11 schematically illustrates the depth map of the left image 92L by an arrangement of arrows. More specifically, the depth information of the occlusion region 80L represented by arrows in FIG. 11 is added to the depth map. As described above, in actuality, the depth map is represented by the arrangement of the signed amounts of parallax in this example.

In step S9, the virtual viewpoint image creation device 38 creates a 3D image (virtual viewpoint image) viewed from an arbitrary virtual viewpoint, on the basis of the actual viewpoint image (i.e., the 3D image inputted by the data input/output device 22 in step S1) and the updated depth map.

The created virtual viewpoint image is used for 3D display and 3D printing. More specifically, the image is used in a case of stereoscopically displaying the image on a 3D monitor apparatus (3D viewer), which is not illustrated, or in a case of printing the image on a print medium by the 3D printer, which is not illustrated, in a stereoscopically viewable manner.

The updated depth map and the virtual viewpoint image are stored in the storing device 24 and subsequently output from the data input/output device 22. For example, the map and image are recorded in a removable media. For example, the map and the image are output to a network, which is not illustrated.

Next, a specific example of calculating the occlusion depth information will be described in detail.

Firstly, a first example of calculating the occlusion depth information will be described.

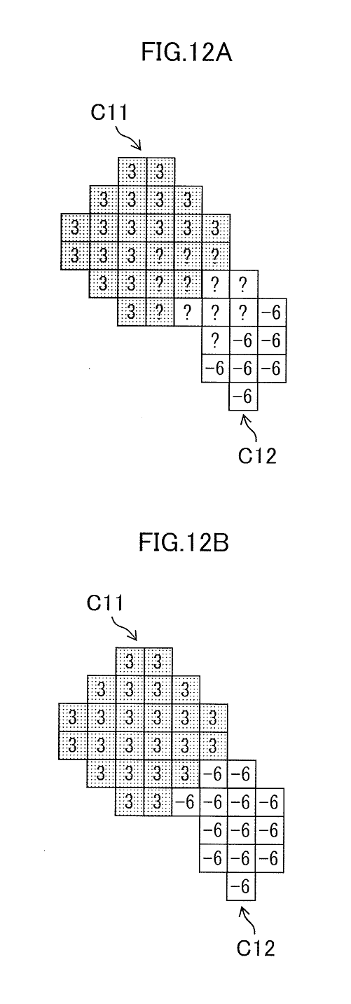

FIGS. 12A and 12B illustrate a part of an example of the depth map. FIG. 12A illustrates a state before update (step S8 of FIG. 3), and FIG. 12B illustrates a state after update. As illustrated in FIG. 12, the occlusion depth information calculation device 36 calculates the average value of non-occlusion pixels (pixels with numerals on the left side in the figure) where the depth information has already been detected for each cluster C11 and C12, and determines the average value as the depth information of the occlusion pixels in each cluster (pixels with ‘?’ symbols on the left side of the figure) where the depth information has not been detected. As illustrated in FIG. 12B, for example, in a cluster C11, since the average value is “+3”, “+3” is set to the depth information of the occlusion pixel. In a cluster C12, since the average value is “−6”, “−6” is set to the depth information of the occlusion pixel.

According to this example, the depth information of each pixel in the occlusion region is determined for each of the divided clusters on the basis of the amount of image feature, thereby increasing accuracy of the depth information in the occlusion region.

Note that the depth information of the occlusion pixel in the cluster without non-occlusion pixel is calculated on the basis of the depth information of another cluster selected on the basis of the amount of feature of the focused cluster. A specific example thereof will be described in a next second example. Another publicly known method may be used.

Next, a second example of calculating the occlusion depth information will be described.

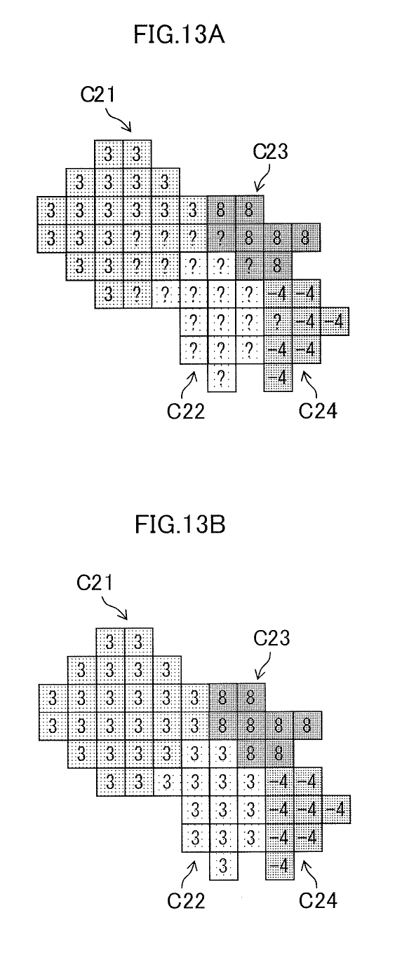

FIGS. 13A and 13B illustrate a part of an example of the depth map. FIG. 13A illustrates a state before update, and FIG. 13B illustrates a state after update. In FIG. 13A, the clusters C21, C23 and C24 include a plurality of non-occlusion pixels where the depth information has already been detected, and the average values of the depth information are “3”, “8” and “−4”, respectively. The cluster C22 does not include any non-occlusion pixel. When the focused cluster includes the non-occlusion pixels, the occlusion depth information calculation device 36 of this example determines the average value of the depth information in the focused cluster as the depth information of the occlusion pixels in the focused cluster. In this example, the depth information of the occlusion pixels in the clusters C21, C23 and C24 are set to “3”, “8” and “−4”, respectively. On the other hand, when the focused cluster does not include any non-occlusion pixel, the occlusion depth information calculation device 36 determines the average value of the depth information in the cluster whose amount of feature of the partial image is the closest to the amount of feature of the focused cluster among the plurality of clusters in the image reference region as the depth information of the occlusion pixels in the focused cluster. In this example, the depth information of the occlusion pixels in the cluster C22 is determined as “3”, which is the average value of the depth information of the cluster C21 whose amount of feature is the closest. For example, the cluster whose color is the closest is selected. The selection may be made on the basis of both the color and luminance. The selection may be made on the basis of the texture. The selection may be made on the basis of high frequency components of luminance or a specific color component (i.e., spatial frequency).

According to this example, with respect to the cluster without any non-occlusion pixel, the depth information of the occlusion pixels is determined using the average value of the depth information in the cluster where the amount of feature of the partial image is the closest. This allows the accuracy of the depth information in the occlusion region to be improved.

Next, a third example of calculating the occlusion depth information will be described.

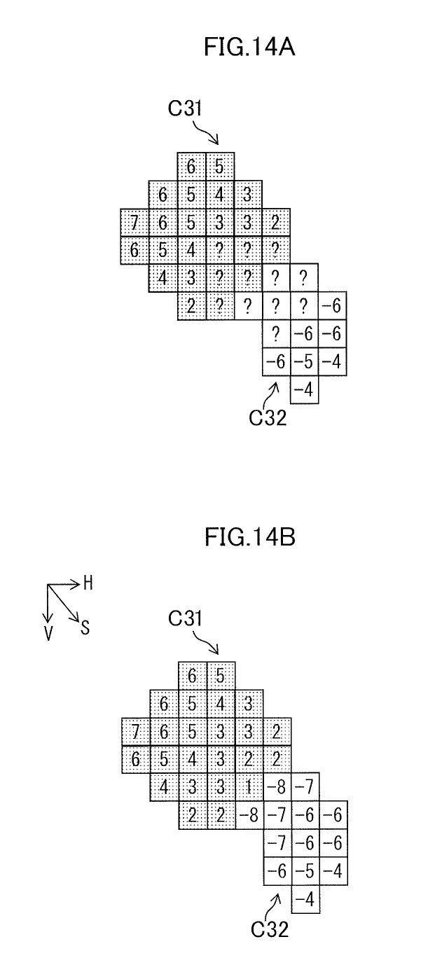

FIGS. 14A and 14B illustrate a part of an example of the depth map. FIG. 14A illustrates a state before update, and FIG. 14B illustrates a state after update. In FIG. 14A, each of the clusters C31 and C32 includes non-occlusion pixels where the depth information has already been detected. The occlusion information is inclined in the cluster. The occlusion depth information calculation device 36 calculates distribution information that represents a distribution of the depth information in the non-occlusion region for each of clusters C31 and C32, and calculates the depth information of the occlusion pixels in each of the clusters C31 and C32 on the basis of the distribution information. For example, the occlusion depth information calculation device 36 detects the inclination of the depth information in at least any one of the horizontal direction H, the vertical direction V and a slanting direction S with respect to each of the clusters C31 and C32, and calculates the depth information of the occlusion pixels according to the inclination.

According to this embodiment, even if the depths of the non-occlusion pixels are inclined in the cluster, the depth information in the occlusion region can appropriately be calculated.

The depth information of the occlusion pixels in the cluster without any non-occlusion pixel may be calculated on the basis of the depth information of another cluster selected on the basis of the amount of feature of the focused cluster.

Further, it is determined whether the depth information of the non-occlusion pixels includes an inclination or not, for every cluster. When it is determined that the inclination is less than a threshold (or without inclination), the average value of the depth information of the non-occlusion pixels of each cluster may be regarded as the depth information of the occlusion pixels as described in the first example.

Next, a specific example of determining the image reference region will be described.

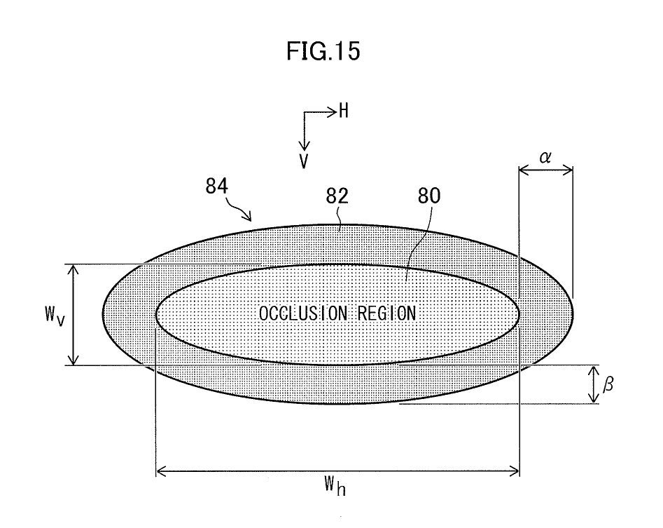

FIG. 15 is an illustration diagram illustrating the first example of determining the image reference region. As illustrated in FIG. 15, the image reference region determination device 34 of this example sets a nearly band-shaped peripheral region 82 having a prescribed width on the periphery of occlusion region 80. That is, the region is determined so as to extend the image reference region 84 from the occlusion region 80 by the prescribed width. For example, in FIG. 15, an extension width α in the horizontal direction H and an extension width β in the vertical direction V are identical (α=β) to each other.

From a standpoint of improving accuracy of depth information, it is more preferable to change the expansion widths α and β according to the shape of the occlusion region 80. For example, in FIG. 15, provided that the width of the occlusion region 80 in the horizontal direction H is Wh and the width thereof in the vertical direction V is Wv, it is specified that α=Wh/2 and β=Wv/2. That is, the peripheral region 82 having widths (α, β) with a certain ratio relative to the widths (Wh, Wv) of the occlusion region 80 is set. It is more preferable that the areal ratio of the occlusion region 80 and the peripheral region 82 be substantially 1:1.

The description has been made using the example of the case of imaging from two viewpoints. However, needless to say, the presently disclosed subject matter may be applied to cases of three viewpoints or more.

The description has been made using the example of image processing by a so-called computer apparatus. However, the presently disclosed subject matter is not specifically limited to such a case. For example, the presently disclosed subject matter may be applied to various apparatuses such as a 3D digital camera, a 3D viewer and a 3D printer.

The presently disclosed subject matter is not limited to the examples described in this specification and the examples illustrated in the figures. It is a matter of course that various modifications of design and improvements may be made within a scope without departing from the gist of the presently disclosed subject matter.

What is claimed is:

1. An image processing apparatus, comprising:
an image input device configured to input a plurality of images acquired by imaging a subject from a plurality of viewpoints;
a correspondence detection device configured to detect a correspondence of each pixel between the images;
a depth map creation device configured to calculate depth information of the pixel whose correspondence has been detected and creates a depth map including the depth information;
an image reference region determination device configured to regard a region consisting of occlusion pixels, whose correspondences have not been detected, as an occlusion region and determine an image reference region including the occlusion region and a peripheral region surrounding the occlusion region;
a region dividing device configured to divide the image reference region into a plurality of clusters on the basis of an amount of feature of a partial image in the image reference region;
an occlusion depth information calculation device configured to focus on each cluster and calculate the depth information of the occlusion pixel in the focused cluster on the basis of the depth information in at least one cluster from the focused cluster, and clusters selected on the basis of the amount of feature of the focused cluster in the depth map; and
a depth map update device configured to add the depth information of the occlusion pixel to the depth map.

2. The image processing apparatus according to claim 1, wherein
the region dividing device divides the image reference region on the basis of, at least one of color, luminance, spatial frequency and texture of the partial image which are used as the amount of feature.

3. The image processing apparatus according to claim 1, wherein
the occlusion depth information calculation device calculates an average value of the depth information of pixels whose correspondences have been detected for each cluster, and regards the average value as the depth information of the occlusion pixels.

4. The image processing apparatus according to claim 1, wherein
the occlusion depth information calculation device regards an average value of the depth information in the focused cluster as the depth information of the occlusion pixels in the focused cluster when a pixel whose correspondence has been detected resides in the focused cluster, and selects a cluster whose amount of feature is the closest to the amount of the feature of the focused cluster from among the plurality of clusters in the image reference region and regards an average value of the depth information in the selected cluster as the depth information of the occlusion pixels in the focused cluster when the pixel whose correspondence has been detected does not reside in the focused cluster.

5. The image processing apparatus according to claim 1, wherein
the occlusion depth information calculation device calculates distribution information representing a distribution of the depth information for each cluster, and calculates the depth information of the occlusion pixel on the basis of the distribution information.

6. The image processing apparatus according to claim 1, wherein
the image reference region determination device sets a nearly band-shaped peripheral region having a certain width on the periphery of the occlusion region.

7. The image processing apparatus according to claim 1, wherein
the image reference region determination device sets the peripheral region having a width with a certain ratio relative to a width of the occlusion region on the periphery of the occlusion region.

8. An image processing method, including:
a correspondence detection step that detects a correspondence of each pixel between images acquired by imaging a subject from a plurality of viewpoints;
a depth map creation step that calculates depth information of the pixel whose correspondence has been detected and creates a depth map including the depth information;
an image reference region determination step that regards a region consisting of occlusion pixels, whose correspondences have not been detected, as an occlusion region and determines an image reference region including the occlusion region and a peripheral region surrounding the occlusion region;
a region dividing step that divides the image reference region into a plurality of clusters on the basis of an amount of feature of a partial image in the image reference region;
an occlusion depth information calculation step that focuses on each cluster and calculates the depth information of the occlusion pixel in the focused cluster on the basis of the depth information in at least one cluster from the focused cluster, and clusters selected on the basis of the amount of feature of the focused cluster in the depth map; and
a depth map update step that adds the depth information of the occlusion pixel to the depth map.

9. The image processing method according to claim 8, wherein
the method divides the image reference region on the basis of, at least one of color, luminance, spatial frequency and texture of the partial image which are used as the amount of feature.

10. The image processing method according to claim 8, wherein
the occlusion depth information calculation step calculates an average value of the depth information of pixels whose correspondences have been detected for each cluster, and regards the average value as the depth information of the occlusion pixels.

11. The image processing method according to claim 8, wherein
the occlusion depth information calculation step regards an average value of the depth information in the focused cluster as the depth information of the occlusion pixels in the focused cluster when a pixel whose correspondence has been detected resides in the focused cluster, and selects a cluster whose amount of feature is the closest to the amount of the feature of the focused cluster from among the plurality of clusters in the image reference region and regards an average value of the depth information in the selected cluster as the depth information of the occlusion pixels in the focused cluster when the pixel whose correspondence has been detected does not reside in the focused cluster.

12. The image processing method according to claim 8, wherein
the occlusion depth information calculation step calculates distribution information representing a distribution of the depth information for each cluster, and calculates the depth information of the occlusion pixel on the basis of the distribution information.

13. The image processing method according to claim 8, wherein
the image reference region determination step sets a band-shaped peripheral region having a certain width on the periphery of the occlusion region.

14. The image processing method according to claim 8, wherein
the image reference region determination step sets the peripheral region having a width with a certain ratio relative to a width of the occlusion region on the periphery of the occlusion region.
